(19) United States
(12) Patent Application Publication
(10) Pub. No.: US 2003/0154059 A1
(43) Pub. Date: Aug. 14, 2003

(54) Simulation apparatus and simulation method for a system having analog and digital elements

(76) Inventors: Jorg-Uwe Feldmann, Munchen (DE); Michael Gunther, Karlsruhe (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/307,828

(22) Filed: Dec. 2, 2002

(30) Foreign Application Priority Data
Nov. 30, 2001 (DE) 101 60 506.4
Sep. 2, 2002 (DE) 102 41 090.9

(51) Int. Cl. G06F 17/10

(52) U.S. Cl. 703/2

(57) ABSTRACT

A simulation apparatus for a system has at least one analog and at least one digital element, in particular an electronic system. The simulation apparatus has an apparatus for solving differential algebraic equation systems based on a one-step method for automatically producing a data record with a simulation event. A detector is provided for automatically determining that a threshold value has been exceeded within one time step in the simulation event. The detector determines whether the simulation event is greater at the end of the respective time step than a predetermined tolerance of the respective threshold value. The detector automatically reduces the time step if the tolerance is exceeded, until the tolerance is undershot, in order to determine the point at which the threshold value is exceeded. A transformation device uses values calculated previously for this purpose. It is thus possible to simulate mixed digital-analog systems particularly efficiently.

### BACKGROUND OF THE INVENTION

1. Field of the Invention

The invention relates to a simulation apparatus for simulation of a system having analog and digital elements, in particular an electronic system. The simulation apparatus has an apparatus for solving differential algebraic equations systems based on a one-step method for automatically producing a data record with a simulation event. The invention further relates to a simulation method for simulation of such a system.

Apparatuses for simulation of systems having purely analog elements and purely digital elements are known. In this context, the expression elements refer to a technical subsystem whose input/output response can be described by an analog or digital response, respectively.

One example of an analog response is, for example, the current/voltage response of a resistor in an electronic system. Digital responses are provided, for example, by transistors in an electronic system or a fluid-dynamic change in a flow system on changing from laminar flow to turbulent flow.

The simulation of analog systems is considerably more accurate and more reliable than the simulation of digital systems. However, the modeling complexity and the computation complexity are typically three orders of magnitude higher than for the simulation of digital systems. The computation complexity for analog systems also rises more than linearly with the number of analog elements, so that the size of the systems to be simulated is limited.

However, systems that have elements with an analog and discrete (that is to say digital) response are widely used in engineering.

For the simulation of such mixed systems, in particular electronic systems, attempts have been made to use digital methods to simulate those parts that can be simulated digitally and to use analog methods to simulate the analog parts. However, complete separation is impossible, since analog and digital elements influence one another. This becomes even more important, especially in electronics, since in this case, for example, digital memory elements and analog elements are integrated on one chip. Particularly close interaction occurs, for example, when a system to be controlled is in the form of an analog system, but the regulator is in the form of a digital regulator.

The increasing importance of mixed analog/digital simulation is evident from the fact that previously purely digital simulation languages, such as VHDL and VERILOG, have been expanded in an appropriate manner to VHDL-AMS and VERILOG-A.

A simulation is generally used for configuring an electronic system such as a circuit, whose simulation result is an abstraction of the actual system response. A simulation such as this is necessary to define configuration parameters (for example resistor values) and/or to check the functionality.

In this case, the electronic systems contain components, some of which have an analog response (for example resistors), and some of which have a digital response with discrete events (for example logic gates).

The signal response of the overall system accordingly represents a combination of the analog and digital signals, so that a combined analog/digital simulation is required. This is also referred to as a mixed signal simulation or combined discrete event and continuous simulation.

Such combined analog/digital systems can be described by a non-linear differential algebraic equation (DAE) system. This is a conventional differential equation system, in which the state variables are coupled to one another by algebraic equations.

The equation system is solved by suitable numerical integration methods in the time domain. These integration methods solve the equation system in time steps, with the length of the time steps generally being matched to the system response by appropriate step length control. This is particularly necessary in order to keep estimated errors in the integration process within a predetermined limit. For example, if the system response varies very rapidly, the time steps for integration must be shortened.

An apparatus for simulation of a mixed analog/digital system must include not only an integration method but also measures making it possible to take account of the mutual influence between the digital and analog parts. For example, a digital event may occur within one time step and may have reactions on the analog simulation result. The simulation apparatus must thus recognize the fact that the time step needs to be adapted, to correctly record the mutual influence.

A simulation method for solving this problem is known from U.S. Pat. No. 4,985,860, in which the new time step is found by use of a polynomial interpolation process, with the interpolation polynomial describing the response of the system, that is to say the function values, for the last time steps. However, this is dependent on the need to calculate the interpolation polynomial. The only way to do this in a simple manner is to use a relatively complex integration method, such as a multi-step method (for example Linear Multi Step (LMS)). An LMS method approximates the future time response of the system via a sequence of preceding time steps by use of a polynomial. The process of determining changes caused by digital events within one time step is complex. This method also has problems in simulating certain systems, since the algebraic equations restrict the solution of the differential equation system (high index problem). Evaluation of one interpolation polynomial is not sufficient here.

### SUMMARY OF THE INVENTION

It is accordingly an object of the invention to provide a simulation apparatus and a simulation method for a system having analog and digital elements that overcome the above-mentioned disadvantages of the prior art devices and methods of this general type, which can simulate complex systems containing analog and digital elements, in an efficient manner.

With the foregoing and other objects in view there is provided, in accordance with the invention, a simulation apparatus for a system having at least one analog element and at least one digital element. The simulation apparatus contains an apparatus for solving differential algebraic equation systems based on a one-step method and automatically producing a data record with a simulation event, and a detector for automatically determining when a threshold value has been exceeded within one time step in the simulation event. The detector determines if a simulation result at an end of a respective time step is greater than a predetermined tolerance of the threshold value. The detector automatically reduces the respective time step if the predetermined tolerance has been exceeded, until the predetermined tolerance has been undershot, to determine a point at which the threshold value has been exceeded. A transformation device using values calculated previously is used for assisting in calculating a reduced time step.

Mixed analog/digital systems can be simulated efficiently by the interaction of a one-step method, for producing a simulation result, and a detector according to the invention.

The detector for automatically determining when a threshold value has been exceeded within one time step in the simulation result determines whether the simulation result at the end of the respective time step is greater than a predefined tolerance on the respective threshold value. In this case, if the tolerance is exceeded, the detector automatically reduces the time step and defines a new value of the simulation result on the basis of an interpolation of the one-step method, until the tolerance is undershot, in order to determine the point at which the threshold value is exceeded.

A simulation apparatus such as this can be implemented on a computer, on a chip or on a model-based regulator.

In accordance with an added feature of the invention, the transformation device uses an interpolation method.

In accordance with another feature of the invention, the data record with the simulation event is automatically stored and/or indicated.

In accordance with a further feature of the invention, the system is an electronic system.

With the foregoing and other objects in view there is provided, in accordance with the invention, a method for simulating a system having at least one analog element and at least one digital element. The method includes using an apparatus based on a one-step method for solving differential algebraic equation systems for automatically producing a data record with a simulation event, and using a detector for automatically determining when a threshold value has been exceeded within one time step in the simulation event. The detector determines whether the simulation event is greater at an end of a respective time step than a predetermined tolerance of the simulation event. The detector automatically reduces the respective time step and automatically sets a new value of the simulation event when the predetermined tolerance has been exceeded, until the predetermined tolerance has been undershot, in order to determine a point at which the threshold value has been exceeded. A transformation device using previously calculated values is used for calculating a reduced time step.

Other features which are considered as characteristic for the invention are set forth in the appended claims.

Although the invention is illustrated and described herein as embodied in a simulation apparatus and a simulation method for a system having analog and digital elements, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1A-1C are graphs illustrating an interaction between an analog and a digital part of a system;

FIGS. 2A-C are graphs showing a process for determining a threshold value of an analog function, and numerical costs by using a bisection method, as well as in the case of the method according to the invention in comparison to the bisection method;

FIG. 3 is a graph showing the numerical costs for determining a threshold value of the analog function (Calaveras method);

FIG. 4 shows an illustration of an algorithm for determining an event time using one-step methods;

FIG. 5 shows a description of the CHORAL integration method;

FIG. 6 shows a table of coefficients for the CHORAL method;

FIG. 7 shows a summary of the CHORAL method;

FIG. 8 shows an illustration of the method according to the invention applied to the CHORAL method; and

FIG. 9 shows an illustration of an advantageous refinement of the method according to the invention.

### DESCRIPTION OF THE PREFERRED EMBODIMENTS

The fundamental problem of mixed analog/digital simulation will be described first in the following text, before describing an embodiment of an apparatus according to the invention and of a method according to the invention.

The essence of the simulation problem is to simulate digital and analog parts of a system that are closely coupled to one another.

In this case, the effect of digital elements of the system on analog elements of the system is comparatively simple. The exact time of the next digital event can be calculated explicitly in advance. The simulator for the analog elements calculates a solution for the analog part up to the time of this event, taking account of all the digital states that have occurred prior to that time. The analog simulation is then continued from the time at which a digital state changes.

The converse situation, in which the time at which the analog part acts on a discrete part cannot be calculated in advance, is more difficult since this time is dependent on whether a specific threshold value of the analog part has been overshot or undershot. A digital state does not change until this occurs. In the VHDL-AMS language, this is modeled by the ABOVE construct, for example:

OutofBound≦Output′ ABOVE(Bound).

The digital value OutofBound changes its value when the analog variable “Output” exceeds the threshold value “Bound”. The threshold value “Bound” may itself depend on analog or digital values. However, the model of the overall system can be reformulated such that it is constant, and this is assumed in the following text.

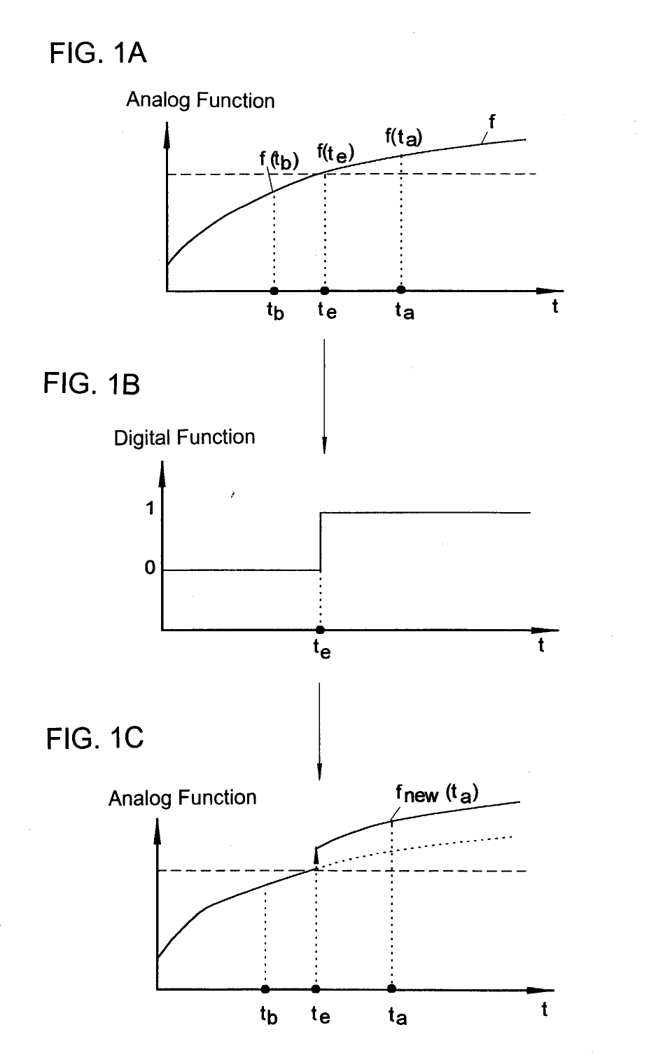

This relatively difficult situation is illustrated in FIGS. 1A to 1C. The analog function f exceeds a threshold value f(tₑ) at a time tₑ. In this case, the time tₑ occurs in a time interval [t_{b}, tₐ], which is an integration interval in this case (FIG. 1A). It can then be seen from FIG. 1B that the digital part of the system changes its value from 0 to 1 at the time tₑ.

If the integration process is carried out over [t_{b}, tₐ], the value for f(tₑ) can be found only if tₑ is not accidentally located at the boundaries of the integration interval.

As soon as the time tₑ has been determined, it is possible to calculate the reaction of the change in the digital value on the analog function, as is illustrated in FIG. 1C. The value f(tₑ) as well as the subsequent value f_{new}(tₐ) change by the changed digital value.

This procedure is implemented by five steps as now described.

Step 1:

The analog simulator calculates a solution f(tₑ) (threshold value) relating to the time tₑ. This step is not required if a function evaluation has already been carried out at this point. Otherwise, this step may require backtracking in order to find the time tₑ in one interval.

Step 2:

The digital signal which is logically linked to the threshold value f(tₑ) is switched, and the digital part of the simulator determines the new digital state of the system which has been initiated by this event.

Step 3:

If one of the digital signals in the system has a reaction on the analog part of the system, then the analog part of the simulator calculates a new consistent analog solution.

Step 4:

If the new analog solution results in further digital events being changed owing to the threshold values being exceeded, then steps 2 and 3 are repeated.

Step 5:

Once all the reactions of the digital events relating to the time tₑ on the analog part have been evaluated, the simulation relating to the time tₑ is restarted.

Owing to the feedback of the digital part of the system onto the analog part of the system, all the analog solutions for t>tₑ with old, incorrect digital states must be rejected, and this is numerically very expensive.

The following text describes how to avoid this problem.

One method, which is relatively inefficient, is based on a bisection method that attempts to find the value of tₑ by an interleaving method.

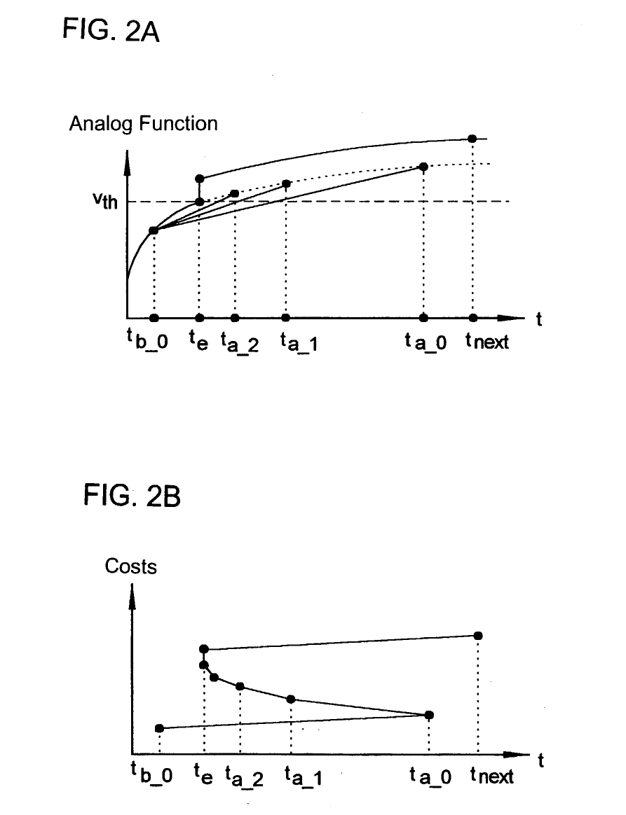

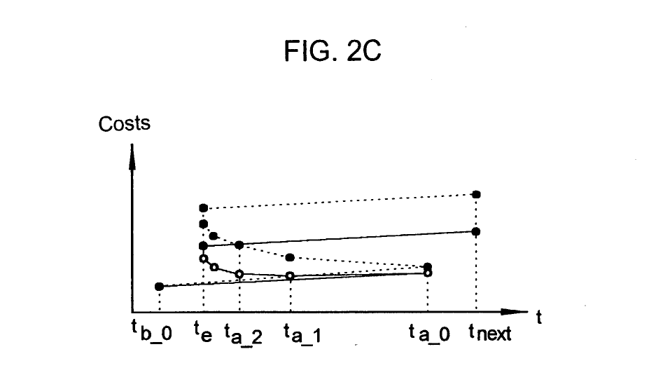

In a similar way to that in FIG. 1C, FIG. 2A shows as the simulation result an analog function f(t) which is influenced by a change in a digital value at the time tₑ. The threshold value is referred to here as vₜₕ (th: threshold).

The normal integration interval [t_{b0}, tₐ₀] includes this time. By way of example, tₑ can be determined as far as a predetermined accuracy by bisection of the interval [t_{b0}, tₐ₀] calculation of the function value at the interval boundaries, and a comparison to determine whether f(tₑ) occurs within the new interval. A different equation-solving method can also be used as an alternative to a bisection method.

FIG. 2B shows the numerical costs for the function evaluations for each function value of t. This shows that the numerical costs rise severely with a greater approximation to tₑ, that is to say as the accuracy increases. The repeated, expensive calculation of the function values f(t) is the problem which the invention is intended to avoid.

Once tₑ has been determined with the desired accuracy, the new time step tₙₑₓₜ is determined starting from tₑ.

The Calaveras method that is known from U.S. Pat. No. 4,985,860 attempts to reduce this problem by evaluation of a polynomial. This is based on the assumption that the function can be approximated with sufficient accuracy by use of a polynomial, in places. The repeated evaluation of the function values in order to determine the time tₑ at which the threshold value is exceeded is replaced by a polynomial interpolation process.

The support values for the polynomial are values for the time that has just been calculated, as well as support values from previous time steps. This is worthwhile when a multistep method is used for integration, which invariably makes use of preceding function values. Typical multistep methods are Adams-Bashforth, Adams-Moulton, Adams-Störmer or Gear methods.

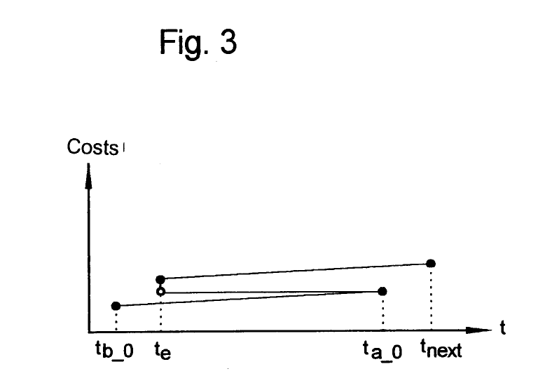

Analogously to FIG. 2B, FIG. 3 shows the numerical costs for determining the approximate value for tₑ by the Calaveras method. The empty circle in this case symbolizes the method in which the polynomial is evaluated once in the interval [t_{b0}, tₐ₀]. The numerical costs are considerably lower than for the method described in FIGS. 2A-2C.

However, the Calaveras method has a number of disadvantages that restrict its practical applicability. The advantages of the Calaveras method become worthwhile when the interpolation polynomial is of the same order as the multistep integration. This is true only when f(x(t)) is a linear function of the variables x(t). In other cases, the direct calculation of the time tₑ leads to inaccurate, or even incorrect, results. This problem may occur, for example, in performance calculations relating to a circuit in which there are non-linear relationships.

Simulators also have to solve systems that cannot be described by a simple formulation of an initial value problem

F(x,x′,t)=0 x(0)=x₀

(x′is the derivative of x in this case and in the following text).

Simulators for charge flow oriented models require methods for solving systems that are described by

F(x,q(x)′,t)=0 x(0)=x₀.

q(x) in this case describes the charge or the flow in one branch of the energy-storage element. Calculations such as these are required, for example, for RC circuits with a voltage-dependent capacitance (C=C₀+C₁*v).

If an LMS method is used, then the numerical integration is carried out using a polynomial of order 0 of q(t) and not with a polynomial of order 0 of x(t). It would therefore not be correct to carry out the interpolation of f(x(t)) with the same order as for q(t) if q(t) were to depend in a non-linear manner on x. This is often the case, especially with semiconductor components.

A further problem is that the differential equation systems to be solved are restricted by algebraic equations; these are differential algebraic equation (DAE) systems. The variables to be integrated are linked by algebraic equations so that they cannot simply be solved by LMS integration of a multi-step method. This applies in particular to so-called high index problems. The (differential) index of a DAE system is defined as the minimum number of differentiations that are required to change the DAE system to a system of conventional differential equations. A conventional differential equation system therefore has an index of zero. If the index is equal to one, then the subsystem of the algebraic equations is regular, so that it can be solved at any time using the differential equation system. However, with LMS methods, DAE systems with an index of more than one cannot be solved in a simple manner.

The apparatus according to the invention for simulation of systems having analog and digital elements thus replaces the linear multistep method by a one-step method. One-step methods use only one previous value x(t) to calculate a new value x(t+h), where h is the step width. A solution at the right-hand boundary of the interval x(t+h) by addition of a specific stage increment Δ xₛ to the value x(t):

$$x ( t + h ) = x ( t ) + {\sum }_{s = 1}^{k} Δ {x}_{s}$$

The calculation of the stage increment normally requires the evaluation of the function F at support points t+cₛ*h, 0≦cₛ≦1, s=1, . . . , k and, finally, since only implicit methods can be used for the class of problems to be solved here, the solution of a large non-linear or linear equation system. The calculation of this increment is the numerically most expensive step in one-step methods.

Typical one-step methods are the Euler-Cauchy and Runge-Kutta methods.

Implicit integration methods that are characterized in general form by the approximation of the following integral

$$x ( t + h ) = x ( t ) + {\int }_{t}^{t + h} {x}^{′} ( τ ) ⅆ τ$$

by a weighted sum of k derivatives of the steps xₛ′ are of particular interest here:

$$x ( t + h ) = x ( t ) + h {\sum }_{s = 1}^{k} {b}_{s} {x}_{s}^{′} = x ( t ) + {\sum }_{s = 1}^{k} Δ {x}_{s}$$

The previous equation approximates x′ at intermediate times t+cₛ h (s=1, . . . , k) The associated values

$${x}_{s} = x ( t ) + {\int }_{t}^{t + {c}_{s} h} {x}^{′} ( τ ) ⅆ τ = x ( t ) + h {\sum }_{j = 1}^{k} {a}_{sj} {x}_{j}^{′}$$

are approximations for x(t+cₛh) (s=1, . . . , k) so that the equation F(x,x′,t)=0 where x(0)=x₀ is satisfied in the following form:

F(xₛ,xₛ′,t+cₛh)=0 where s=1, . . . ,k

The number k of stages and of coefficients aₛⱼ, bₛ, cₛ (s, j=1, . . . , k) are defined such that specific characteristics of the chosen method, such as consistency, convergence order and stability, are satisfied.

For each one-step method, it is normally necessary to calculate the function value F, and possibly even the derivatives of F, at intermediate support points t+cₛh (s=1, . . . , k) in order to calculate the increment. Large non-linear or linear equation systems also need to be solved.

From the large number of one-step methods, certain methods are particularly suitable for the present task. Characteristics of the particularly suitable methods are described in the following text.

1. The one-step method must be able to solve a DAE system for charge-flow-oriented models.

The initial value problem is in the form

Aq(x)′+g(x,t)=0 x(0)=x₀,

which occurs frequently in simulation tasks with analog and digital elements. In this case, a matrix A is introduced as an incidence matrix with elements (0, 1, −1). The functions q(x), g(x,t) are non-linear functions of the dynamic and steady-state parts, respectively, of the analog part of the system. The incidence matrix A is generally singular, so that +the DAE index is greater than or equal to 1. For practical applications, it is sufficient to consider problems with a DAE index of less than or equal to 2.

2. It must be possible to calculate the stage increments Δ xₛ (s=1, . . . , k) sequentially, with the sequence of the stage increments giving improved accuracy for the solutions x(t+h).

The advantage in this case is that a first-order estimate for x(t+h), which can be used for checking whether threshold values have been exceeded, is obtained at relatively low numerical costs. Further numerical costs are incurred only if the check fails, so that further stage increments are required for greater accuracy.

According to the invention, implicit Runge-Kutta and Rosenbrock-Wanner methods are advantageously used, which are known from the literature (for example Deuflhard, Bornemann, Numerische Mathematik II [Numerical Mathematics II], de Gruyter, Berlin 1994).

One advantage of one-step methods is that the integrator can be started again after a discontinuity with a high order. A higher integration order generally results in a greater step width. This is an advantage in comparison to LMS methods, which always have to start with the order one once again after a discontinuity.

The invention relates to the efficient checking of events between analog and digital sections, and this is achieved by the following method steps.

Step 0:

Initialization with: t_{b}=t, tₐ₀=t+h, j=0, sₐ=0

The counter for the stage increment Δ xₛ is set: s=1.

Step 1:

A new time t in the interval [t_{b}, tₐⱼ] is defined by bisection or interpolation.

Step 2:

If s>sₐ, then:

calculation of the stage increment Δ xₛ for t by the analog part of the simulator,

otherwise

the stage increments Δ x₁, . . . , Δ xₛ for t are calculated by a transformation process (mapping) tₐⱼ.

An approximate solution is calculated for xₛ(t): xₛ(t)=x(t_{b})+Δ x₁+ . . . +Δ xₛ

Step 3:

The function value f(xₛ(t)) is calculated from the approximate solution xₛ(t) and from the current digital states of the system.

Step 4:

If s<k then

if the mathematical sign of (f(xₛ(t))−vₜₕ) and the mathematical sign of (f(t_{b})−vₜₕ) are undoubtedly different,

then

jump back in time: j:=j+1, tₐⱼ=t, sₐ=s;

Further stages in the increment are jumped over: restart with step 1

otherwise, if the mathematical sign of (f(xₛ(t))−vₜₕ) and the mathematical sign of (f(t_{b})−vₜₕ) are undoubtedly the same, then

reject the time, jump over further steps and restart with step 1

otherwise

increase the stage number s and go to step 2

vₜₕ is the threshold value here. The expression “undoubtedly different” in this context means that the mathematical sign is different within an error limit ε of f(xₛ(t)). This can be determined, for example, by a test with somewhat damped increments by, for example, comparing the mathematical signs of

{f(x(t_{b})+λₛ (xₛ(t)−x(t_{b})))−vₜₕ} and

{f(x(t_{b}))−vₜₕ}

The damping parameters λₛ (s=1, . . . , k) are chosen such that 0<λ₁<λ₂< . . . <λₖ=1.

One suitable choice is, for example, λ₁=0.8, λ₂=0.95, which reflects the increase in the accuracy of xₛ(t) as the number of stages increases.

The advantage of this step is that it results in a first-order estimate for x(t+h) with relatively low costs, which estimate can be used for an initial test to determine whether the threshold value has been exceeded. Greater complexity for calculating higher increments and for a higher accuracy need be accepted only if the test fails.

Step 5:

If |f(x(t))−vₜₕ|≦ε₁ and tₐⱼ≦ε₂ then

STOP

otherwise, if the mathematical sign of {f(xₛ(t))−vₜₕ} and the mathematical sign of {f(t_{b})−vₜₕ} are not the same, then

time step back:

j:=j+1, tₐⱼ=t, sₐ=s

Restart with step 1

otherwise

reject the time step and restart with step 1.

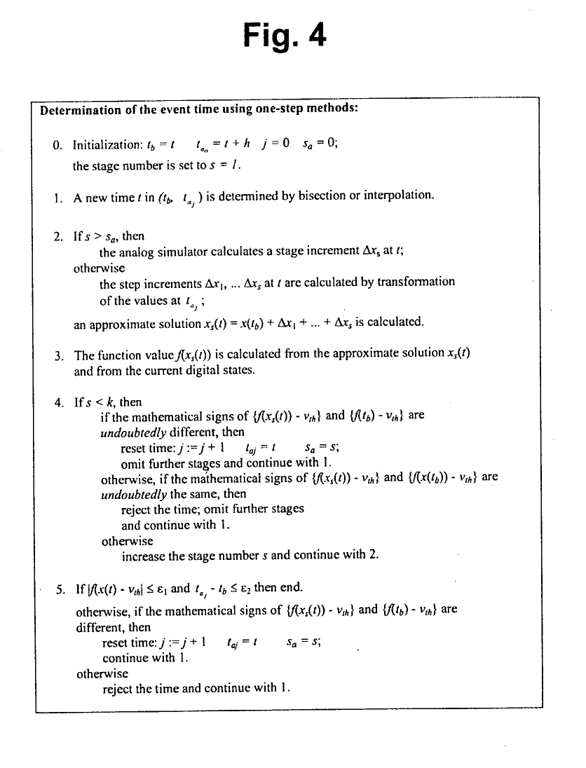

This method is described in a compact manner in FIG. 4. A simulator apparatus according to the invention has a data memory that can carry out these steps. A detector is used to carry out steps 4 and 5 in order to detect the threshold values vₜₕ. A transformation device is used to transform the already calculated values to a shorter time interval (steps 2 and 3). After completion of the calculation, a data record with the solution is produced automatically and, if required, is indicated in the form of a graph.

The described method for finding events is particularly efficient if it is possible to carry out a transformation (mapping) of the stage increments Δ xₛ in the one-step method for a given time step h to an associated increment Δ xₛ* for a shorter time step h*. In this context, the expression efficient means that there is no need for any expensive function evaluations of the function F(xₛ*, xₛ′*, t+cₛ* h) in order to determine Δ xₛ*. This association is particularly useful for jumps back in time in the above algorithm (steps 4 and 5).

The following methods may be used for transformation (mapping) of the increment Δ xₛ−>Δ xₛ* for time steps h−>h*:

1. Use of a basically known dense output method, such as Hermite interpolation.

2. Use of an embedded method for determining the solution for the step length h*, with this method being of the same order and having similar stability characteristics to the original which was constructed for a different time step h*, but uses the same steps:

t+c*jh*=t+cⱼh(j=1, . . . , s).

3. When using semi-implicit methods, it may be possible to calculate Δ xₛ* directly by using linear algebra from the stage increment Δ xₛ. The numerical costs for this are low.

The use of one of these methods leads to a considerable reduction in the function evaluations when searching for the time at which the threshold value is exceeded. If the time step h is reduced to a time step h′, then the increment stage xₛ(t_{bi}+h′), which was calculated in step 2, can be calculated from the value xₛ(t_{bi}+h) with relatively low numerical costs.

The advantages of the apparatus according to the invention and of the method according to the invention are illustrated in FIGS. 2A-2C. In FIG. 2c, the numerical costs of a known procedure as shown in FIG. 2A (solid circles) are compared with the numerical costs for the method according to the invention (empty circles). The costs for jumps back in time are considerably reduced, since the steps of the increments are either not calculated, or can be calculated on the basis of the transformation device according to the invention.

The efficiency is somewhat less than that of the algorithm in U.S. Pat. No. 4,985,860, but this is counterbalanced by the fact that a broader class of problems can be solved, especially with regard to the index.

As an example of one practical application, the following text describes a simulator for electronic systems which, inter alia, uses the CHORAL integrator (M. Günther, Simulating Digital Circuits Numerically—A Charge Oriented ROW Approach, Numer. Math. 79, 203-212 (1998)). CHORAL satisfies the requirements mentioned above for a one-step method for the simulator according to the invention. CHORAL is a semi-implicit order 2 (3) Rosenbrock-Wanner (ROW) integrator with 4 stage increments and 3 function evaluations per time step. The CHORAL integrator was developed in particular for simulation of circuits in a charge flow form, having the capability to solve index 2 problems. One implementation of the integrator has been produced by M. Hoscheck in the reference titled “Einschrittverfahren zur numerischen Simulation elektrischer Schaltungen” [One-Step Methods For Numerical Simulation Of Electrical Circuits], VDI-Verlag, Dusseldorf, 1999).

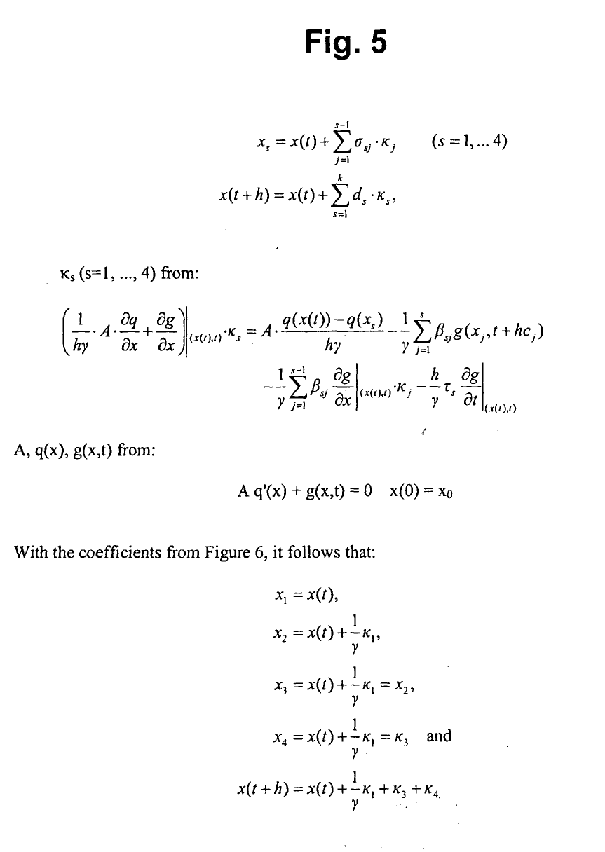

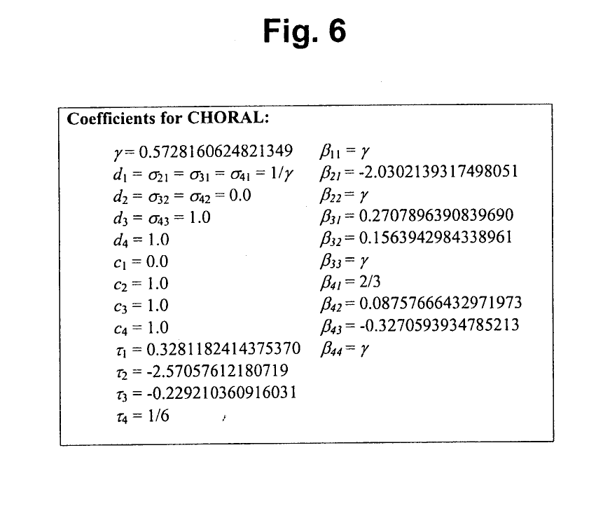

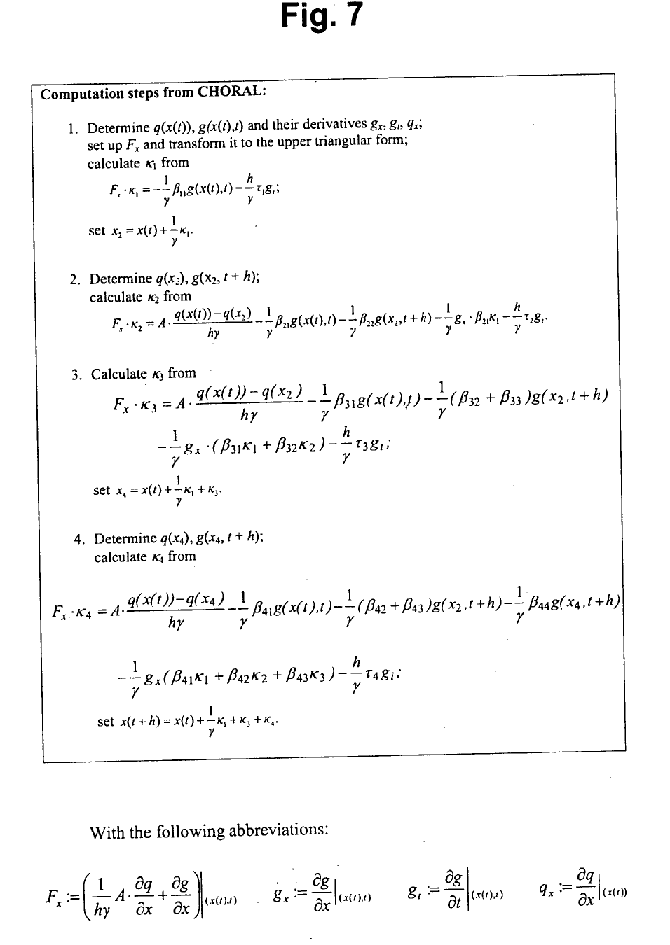

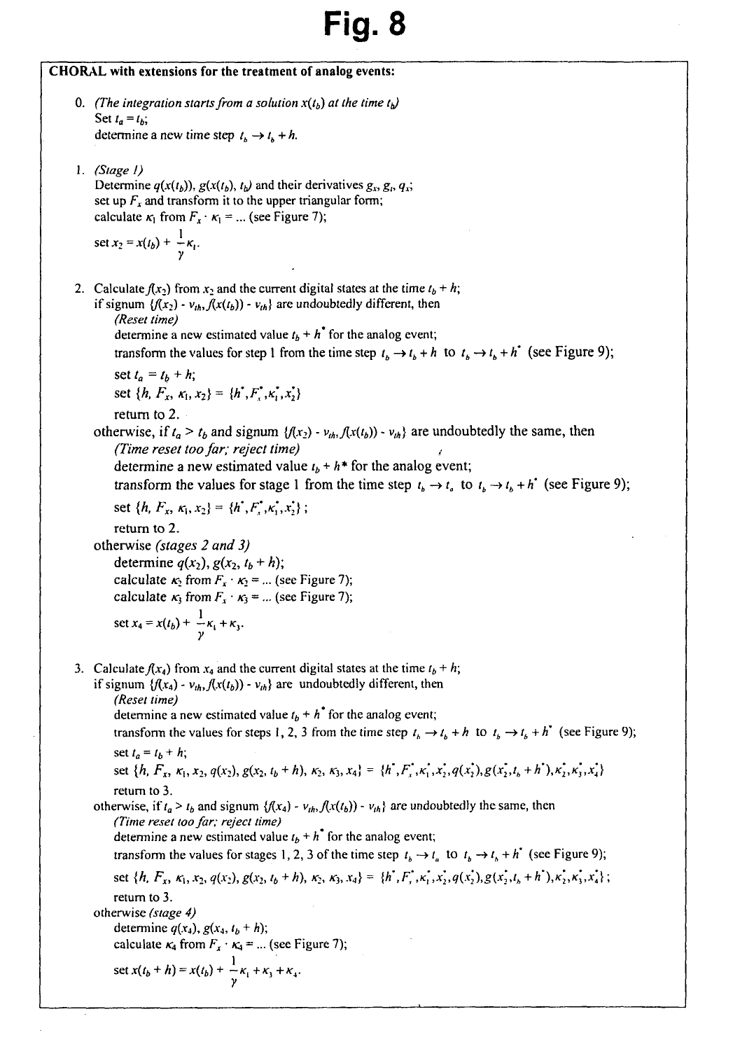

FIG. 5 shows the calculation of the stage values xₛ and of the solution x(t+j) for a time step t−>t+h. FIG. 6 contains the coefficients that are required. The method of operation of the CHORAL method is summarized in FIG. 7.

The stage values can be determined sequentially:

x₂ after one evaluation of the function and its derivative

x₃=x₂

x₄ after two function evaluations

x(t+h) after the third function evaluation.

The approximation of the solution at t+h is carried out with increasing accuracy order.

x₂ first-order approximation

x₄ second-order approximation

x(t+h) third-order approximation, final value.

The method according to the invention, which is described above and in FIG. 4, is now linked to the CHORAL method. This is illustrated in FIG. 8. In this case, a number of details of the CHORAL method have been omitted for clarity reasons, such as step width monitoring, termination criteria and rejection of time steps.

The first case, of step 4 in FIG. 8, represents the end of a normal integration step, in which no analog event occurs. If tₐ>t_{b}, then one event exists in the interval [t_{b}, . . . , tₐ] and tₐ is set back until the event is determined with sufficient accuracy. The rejection of a time step (that is to say in the second case in steps 2 and 3 and in the last case in step 4) is necessary when setting back the time was too pessimistic, so that the new time step no longer includes the event. In this case, the time step is started from tₐ.

The described one-step method with the modifications according to the invention has the following characteristics in addition to the advantages of CHORAL:

1. The checking of the events is carried out after steps 1 and 3 and not only once the solution has been determined at the end point of the time step.

2. When setting back the time, results that have been obtained are not rejected, but are used for calculating the next time step.

3. The time can be set back in an efficient manner more than once in each stage, so that there is no need to implement a method for particularly accurate time step shortening.

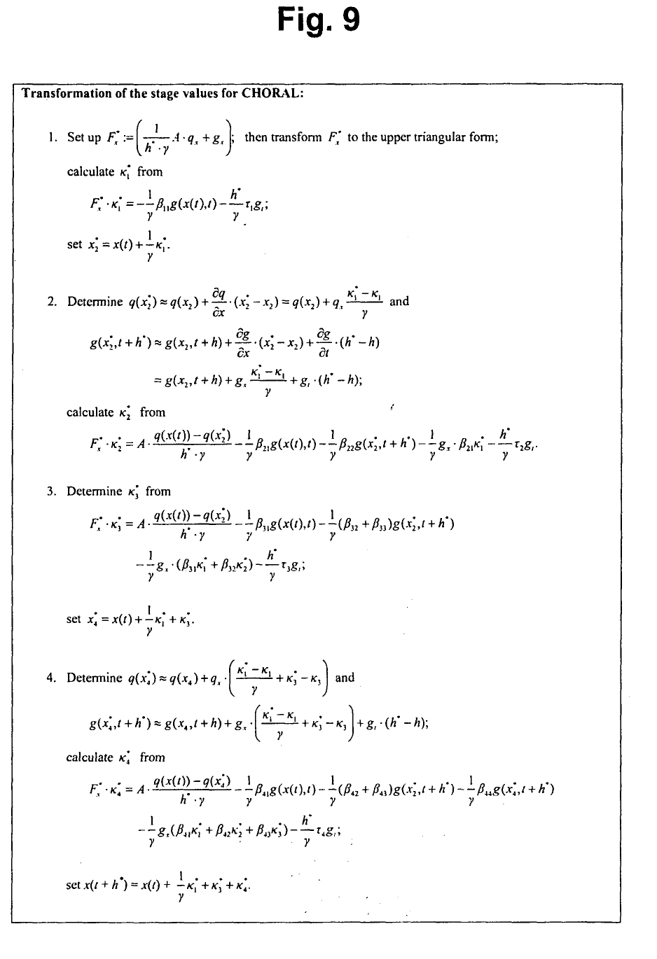

The advantageous transformation (mapping) of the stage values in CHORAL is described in FIG. 9. The transformation results in a projection of the stage values of a time step h onto a shorter time step h* for the situation that is necessary to set back the time. This has already been described above with reference to three possible alternatives. Since CHORAL is a semi-implicit integration method, the third of three methods is used (see FIG. 9).

In this case, only linear algebra steps such as LU breakdown are used for calculating all the stage values for the next time step, and this is numerically cheaper. Costly function evaluations are avoided.

The implementation of the invention is not restricted to the preferred exemplary embodiments described above. In fact, a large number of variants are feasible which make use of the simulation apparatus according to the invention and of the method according to the invention, even for embodiments of a fundamentally different nature.

We claim:

1. A simulation apparatus for a system having at least one analog element and at least one digital element, comprising:
an apparatus for solving differential algebraic equation systems based on a one-step method and automatically producing a data record with a simulation result;
a detector for automatically determining when a threshold value has been exceeded within one time step in the simulation result, said detector determining if the simulation result at an end of a respective time step is greater than a predetermined tolerance of the threshold value, said detector automatically reducing the respective time step if the predetermined tolerance has been exceeded, until the predetermined tolerance has been undershot, to determine a point at which the threshold value has been exceeded; and
a transformation device using values calculated previously for assisting in calculating a reduced time step.

2. The simulation apparatus according to claim 1, wherein said transformation device uses an interpolation method.

3. The simulation apparatus according to claim 1, wherein the data record with the simulation result is automatically at least one of stored and indicated.

4. The simulation apparatus according to claim 1, wherein the system is an electronic system.

5. A method for simulation of a system having at least one analog element and at least one digital element, which comprises the steps of:
using an apparatus based on a one-step method for solving differential algebraic equation systems for automatically producing a data record with a simulation result;
using a detector for automatically determining when a threshold value has been exceeded within one time step in the simulation result, the detector determining whether the simulation result being greater at an end of a respective time step than a predetermined tolerance of the simulation result; using the detector to automatically reduce the respective time step and automatically set a new value of the simulation result when the predetermined tolerance has been exceeded, until the predetermined tolerance has been undershot, in order to determine a point at which the threshold value has been exceeded; and
using a transformation device using previously calculated values for calculating a reduced time step.

6. The method according to claim 5, which comprises simulating an electronic system as the system.
